(19) United States
(12) Patent Application Publication
(10) Pub. No.: US 2007/0292702 A1
(43) Pub. Date: Dec. 20, 2007

(54) Water-Repellent and Self-Cleaning Leather

(76) Inventor: Rupert Saumweber, Lorrach (DE)

Correspondence Address: WENDEROTH, LIND & PONACK, L.L.P., 2033 K STREET N. W., SUITE 800, WASHINGTON, DC, 20006-1021, US

(21) Appl. No.: 11/659,827

(22) PCT Filed: Aug. 9, 2005
(86) PCT No.: PCT/EP05/53907

§ 371 Date: Feb. 9, 2007

(30) Foreign Application Priority Data
Aug. 10, 2004 (CH) 01326/04

(51) Int. Cl. C14C 9/02; C14B 1/46

(52) U.S. Cl. 428/473; 69/21

(57) ABSTRACT

By buffing at least one surface of a leather which has been rendered hydrophobic in cross section, a surface which reduces superhydrophobic and self-cleaning properties of the leather (Lotus-Effekt®) is generated. This leather is particularly suitable for shoes and textiles, but also other commodities.

The present invention relates to a superhydrophobic leather having a self-cleaning surface, a process for the production thereof and the use thereof for the production of commodities, such as, for example, linings, upholstery covers, hats, apparel, belts, suitcases, briefcases and handbags, purses and shoes.

In order to provide leather with a water-repellent or waterproof treatment, tanned hides and furs are treated during the finishing of leathers, in an aqueous liquor, with water repellents which penetrate into the collagen fibres of the leather and are also bound to the surface of the collagen fibres. With this internal treatment, high and permanent water resistances can be achieved even today. Another possibility for imparting hydrophobic properties consists in the subsequent treatment (coating) of crust or completely finished leathers with hydrophobic substances, such as, for example, silicones or organic perfluoro compounds. Although this method entails high costs owing to the expensive raw materials (Scotchgard® products), it has the advantage of repeatability in the case of damage to the surface by the consumer himself. In particular, the repeated treatment of shoes with sprays in order to maintain the water-repellent effect is known here.

The Lotus-Effekt® has been known since about the mid nineties and denotes the water-repellent treatment of hydrophobic surfaces for producing microstructures which, as in the case of the lotus plant, leads to repulsion of water together with a self-cleaning ability of the surface (cf. for example WO 96/04123). From the publication 50th SEPAWA Congress—Bad Durkheim—8-10 Oct. 2003, pages 105 to 117, it is known that self-cleaning properties are also observed in the case of superhydrophobicity of surfaces. The hydrophobicity can be determined in a known manner by the contact angle θ which is made by a liquid drop on the surface of a solid. In the case of smooth surfaces, contact angles of up to 120° can be achieved. Superhydrophobicity occurs only at relatively high contact angles, which can be achieved by microstructuring of the surfaces with hydrophobic materials. Particularly suitable are multiply structured, hierarchically organized surfaces in which the contact area of water drops and dirt particles on a surface can be very considerably reduced so that drops have a virtually ideal spherical shape and roll on the surface and do not spread or penetrate into the material. Dirt particles remain adhering to the surface of the drop and are carried along. Surfaces multiply microstructured in this manner are known from nature and, on the basis of a knowledge of the physical principles for the Lotus-Effekt®, efforts were quickly made to produce such surface structures artificially in order to render surfaces of different commodity materials superhydrophobic and self-cleaning.

The coating of surfaces with nanopartides which have been rendered hydrophobic, for example pyrogenic silica which has been rendered hydrophobic, is an obviously feasible and industrially utilizable technical solution. With the coating, however, a surface of a different material is also produced, which leads to property changes which are not always desired. WO 96/04123 also describes a method in which no other material is used but embossing of softened polymers is carried out. The coating technology has also been proposed for the production of water-impermeable textiles, such as, for example, apparel for outdoor activities.

In a BASF press release of 28-29.10.2002, reference is made to a Lotus-Spray®, with the aid of which different commodity materials, such as, for example, leather, can be coated for producing superhydrophobic and self-cleaning surfaces. The direct production of superhydrophobic and self-cleaning properties of a leather which has been rendered hydrophobic has not yet been described.

It has now surprisingly been found that the surfaces of leather can be rendered superhydrophobic and self-cleaning in a very simple manner and that these properties can even be regenerated if the surface of a leather rendered hydrophobic at least partly in cross section is buffed and a surface which is roughed in the microrange and comprises hydrophobic micro fibres is thus created. The microfibres are elastic and stiff and generally mechanically so stable that they are not compressed in an unexpected manner by a water drop and therefore offer only a very small contact area. The hydrophobicity of these microfibres and the distribution thereof over the surface thus results in pronounced superhydrophobicity with self-cleaning of the surface.

A first subject of the invention is a completely finished leather, of which at least 10% of the cross section from the surface has been rendered hydrophobic, and at least this surface (a) forms a first microstructure on the network of collagen fibres which have hydrophobic collagen fibres and hydrophobic bundles of elementary fibres of collagen which project to different extents a small distance out of the plane of the surface, on which is superposed (b) a second microstructure of finer, hydrophobic fibres which are present as bunches of elementary fibres, as bunches of elementary fibres bundles and fibrils at the end of the collagen fibres and as bundles of elementary fibres, individual elementary fibres and fibrils on the collagen fibres of the network.

Preferably at least 20% and more preferably at least 30% of the cross section are rendered hydrophobic. Since water repellency is today predominantly imparted in tanning drums, the water repellent (or fatliquoring agent) penetrates from both sides through the total leather cross section. It is therefore very particularly preferred if the total cross section of the leather is rendered hydrophobic.

Conventional leather has two different sides. The outer side (the hair side or grain side) has a finer fibre structure. The side facing the animal's body is the flesh side (velour) and has a coarser fibre structure. Each animal species provides an individual hide type. Depending on the type of growth, e.g. wool, hair or bristles, different pore and grain patterns form. Collagen fibres having a diameter up to about 200 μm are present on the flesh side; on the grain side, on the other hand, the collagen fibres usually have a diameter of only 20-30 μm and consist of 30-300 elementary fibres. Elementary fibres have a diameter of about 5 μm. Each elementary fibre in turn consists of 200-1000 fibrils as the smallest unit visible under an optical microscope, which have a diameter of about 0.1 μm.

The collagen fibres as a network form a surface having elevations and depressions, the distance between which is determined mainly by the diameter of the fibres. Accordingly, according to the invention, “small distance” can mean at least the distance between adjacent collagen fibres in the network. However, the distance may also be larger, for example a distance of 2, 3, 4 or 5 collagen fibres. A submicroscopic structure comprising finer fibres is superposed on this primary structure. The submicroscopic structure is substantially composed of fibrils, elementary fibre bunches and bundles of elementary fibres, which may have a diameter of, for example, from 0.1 to 30 μm.

When considered macroscopically, the surface of the leather (grain side) is even with a visible fibre structure and fine roughness (comparable with a three-dimensional felt structure), the surface having a smooth feel. The treated or buffed surface has a microstructure which consists of a microscopic main structure (primary structure) of projecting collagen fibres, on which a submicroscopic structure (secondary structure) of bunches of fine fibres/fibrils is superposed. The main structure consists of collagen fibres which have been rendered hydrophobic and have a small distance of 0 (contact), in the region of the diameter of collagen fibres or more. The distance may be, for example, 0 or may be from 5 μm to 400 μm, preferably from 5 μm to 200 μm. Individual fibres may also be intertwined. The collagen fibres make a right angle or oblique angle with the plane of the surface, so that the fibres or regions of fibres project to different extents from the surface and form elevations and depressions which have distances in the micrometre range, for example from 5 to 200 μm, preferably from 10 to 150 μm, more preferably from 10 to 100 μm and particularly preferably from 10 to 50 μm. The length of the projecting fibres may be, for example, from 5 to 200 μm and preferably from 10 to 150 μm.

The submicroscopic structure is formed by bunches of fibres, fibre bundles and fibrils at the end of the projecting fibres or the surface of collagen fibres in the network. The hydrophobic fibres of the bunches are thinner elementary fibres, bundles of elementary fibres and/or fibrils of the collagen fibres. These fibres and fibrils may have a length of, for example, from 500 nm to 20 μm and preferably from 800 nm to 10 μm, it being possible for the length of individual fibres/fibrils in a bunch to be different. The diameter of these individual fibrils, fibres and fibre bundles may be, for example, from 0.1 to 30 μm and preferably from 0.1 to 20 μm. The diameter of the bunches may be, for example, from 0.1 to 200 μm and preferably from 1 to 100 μm.

The hydrophobic treatment or fatliquoring of tanned leather has long been known, and reference is made to the relevant technical literature. Known fatliquoring agents are natural and synthetic oils and fats as well as waxes, silicones and functionalized silicones, surfactants and amphiphilic or hydrophobic polymers. Fatliquoring agents are frequently used in combinations in order to achieve a high water-repellent effect. Compositions for imparting water repellency to leather which are described in DE 4404890 and in particular WO 03/064707 have proved to be particularly effective.

The leather according to the invention is completely finished, i.e. tanned, retanned, fatliquored and optionally dyed in desired shades. The special microstructure of the buffed surface in combination with the hydrophobicity of the fibres forming the microstructure imparts to the leather superhydrophobic properties which are associated with the self-cleaning ability. The contact angle θ of a water drop resting on the surface is more than 120°, preferably 140° or more and theoretically up to 180° and may be, for example, from 140° to 170°. The drops have a substantially spherical shape. Water drops do not penetrate into the leather even over a relatively long period. In the case of mechanical movement, the water drops roll over the surface. When the surface is at an oblique angle, the drops are observed to roll off immediately. If dirt particles are present on the surface, they are bound to the surface of the water drop when they are rolled over and are thus removed from the leather surface (self-cleaning effect). Owing to the overall property spectrum, the leather according to the invention can be referred to as leather having a “Lotus-Effekt®”.

A particular advantage of the leather according to the invention is the simple regeneration of the effects when the surface is damaged by soiling and/or mechanical damage. Damaged areas can, optionally after cleaning, be buffed in a simple manner with an abrasive, such as an abrasive paper, with the result that the microstructure on the leather surface and the associated properties are restored.

The production of the lotus leather according to the invention is simple, and buffing techniques known in leather production can be used for subsequently modifying the surface of a completely finished leather rendered hydrophobic in cross section.

The invention furthermore relates to a process for the production of a leather according to the invention, which is characterized in that at least one surface of a completely finished leather, of which at least 10% of the cross section from the surface has been rendered hydrophobic, is buffed with a solid abrasive.

The buffing can be effected manually or mechanically and causes roughening of the surface. Solid abrasives are widely known and may be, for example, sheet-like materials which are coated with finely divided particles having irregular surfaces with comers and edges. In addition to abrasive papers, other examples of sheet-like materials are rollers and rolls for mechanical processing. The particles are harder than the leather to be buffed. The degree of roughness can be influenced by the diameter (particle size) and the contact pressure. The particle size is preferably from 260 μm (abrasive paper No. 60) to 5 μm (abrasive paper No. 4000) and particularly preferably from 58 μm (abrasive paper No. 240) to 10 μm (abrasive paper No. 2500).

The contact angle θ of a water drop on the completely finished leather which has been rendered hydrophobic (starting material) may be, for example, from 70° to 120° and preferably from 90° to 120°.

As a result of the buffing, the collagen fibres at the cohesive and planar surface of the starting material are destroyed and torn so that a primary structure comprising more or less upright fibres forms. Owing to the particular structure of the collagen fibres, which consist of elementary fibres and fibrils twisted with one another and branched, the ends are frayed after the buffing and are in the form of irregular fibre bunches at the tears. At the same time, surfaces are only partly torn or frayed in the network of the collagen fibres. Thus, a secondary structure of fine hydrophobic fibres forms, which is necessary for enabling water drops to roll off easily and for taking up dirt particles lying on the surface.

The invention furthermore relates to a leather obtainable by the process according to the invention.

The leather according to the invention can be used or concomitantly used for the production of various commodities in the shoe, apparel, automotive and upholstery industry. Owing to the particular property of the leather as a natural and flexible raw material, a multiplicity of potential applications, including novel ones, are conceivable. It can be used, for example, as furniture leather for chairs and sofas or linings in automobiles or aircrafts or in handbags, briefcases or suitcases. A preferred field of use is the production of shoes and in particular of articles of clothing, such as, for example, hats, caps, coats, jackets, dresses, shirts, trousers, skirts, gloves and belts.

The following examples explain the invention in more detail.
A) Production of Leather Which has been Rendered Hydrophobic

### EXAMPLE A1

### Production of a Leather Which has been Rendered Hydrophobic

The tanned leather used is a wet blue having a shaved thickness of 1.2 mm. The stated percentages are percentages by weight, based on the shaved weight of the leather. The process is carried out as stated in the table below.

TABLE

| Operation | Amount | Temperature | Chemicals | pH | Time |
|---|---|---|---|---|---|
| Washing | 200% | 45° C. | Water | 4.1 | 10 minutes |
| Neutralization | 100% | 25° C. | Water | | |
| | 3% | | Na formate | | Overnight |
| | 2% | | SELLASOL ® NG gran. | | |
| Washing | 200% | 25° C. | Water | | 10 minutes |
| Retanning | 100% | 25° C. | Water | | |
| | 8% | | SELLASOL ® KM liqu. | | |
| | 6% | | SELLATAN ® FB fl. | | |
| | 4% | | Mimosa | | |
| | 3% | | MAGNOPAL ® SFT | | |
| | 2% | | Dye | | 120 minutes |
| | 200% | 50° C. | Water | 4.2 | 10 minutes |
| Washing | 300% | 50° C. | Water | | 10 minutes |
| Fatliquoring | 100% | 50° C. | Water | | |
| | 6% | | Drywalk ® FAT | | |
| | 4% | | Drywalk ® POL | | 60 minutes |
| | 0.5% | | Formic acid | | |
| | 0.5% | | Formic acid | | |
| | 0.5% | | Formic acid | 3.6 | |
| Washing | 300% | 50° C. | Water | | 10 minutes |
| Fixing | 150% | 35° C. | Water | | |
| | 3% | | Chromosal ® BD | | 90 minutes |
| Washing (2×) | 300% | 25° C. | Water | | 10 minutes |

Thereafter, the leather is damped overnight on a frame, set out, dried for 2 minutes while hanging in a vacuum dryer at 80° C., then moistened, staked, and ironed in vacuo at 80° C. for 30 seconds.

SELLASOL® NG gran. is a neutralizing agent. SELLASOL KM liqu. and SELLATAN® FB fl. are syntans. MAGNOPAL® SFT is a polymer (retanning agent). Drywalk® FAT and Drywalk® POL are a water-repellent system and Chromosal® BD is a chromium salt as a fixing agent.
B) Production of Leather with Lotus-Effekt®

### EXAMPLE B1

A leather according to example A1 is buffed using a commercial buffing machine and an abrasive paper with the number 320 (46 μm). The buffed leather has a pronounced Lotus-Effekt® (superhydrophobicity and self-cleaning), water drops rolling off directly and assuming a virtually ideal spherical shape. The contact angle is >160° C.

### EXAMPLE B2

### Regeneration

A part of the surface of the leather according to example B1 is rubbed smooth with glass until the rolling-off effect disappears. The smoothed defects are then carefully rebuffed using an abrasive paper with the number 400 (35 μm). The Lotus-Effekt® is then observed again to the original extent.

1. Completely finished leather, of which at least 10% of the cross section from the surface has been rendered hydrophobic, and at least this surface (a) forms a first microstructure on the network of collagen fibres which have hydrophobic collagen fibres and hydrophobic bundles of elementary fibres of collagen which project to different extents a small distance out of the plane of the surface, on which is superposed (b) a second microstructure of finer, hydrophobic fibres which are present as bunches of elementary fibres, as bunches of elementary fibres bundles and as fibrils at the end of the collagen fibres and as bundles of elementary fibres, individual elementary fibres and fibrils on the collagen fibres of the network.

2. Leather according to claim 1, characterized in that it is rendered hydrophobic in a total cross section.

3. Leather according to claim 1, characterized in that the diameter of the fibrils, elementary fibre bunches and bundles of elementary fibres is from 0.1 to 30 μm.

4. Leather according to claim 1, characterized in that the distance between the projecting collagen fibres is from 5 to 200 μm.

5. Leather according to claim 1, characterized in that the collagen fibres make a right angle or oblique angle with the plane of the surface so that fibres project to different extents from the surface and form elevations and depressions.

6. Leather according to claim 5, characterized in that the length of the projecting collagen fibres is from 5 to 200 μm.

7. Leather according to claim 1, characterized in that the length of the fibres or fibrils in the bunch is from 500 nm to 20 μm.

8. Leather according to claim 1, characterized in that the contact angle θ of a water drop on the surface is from 140° to 170°.

9. Process for the production of a leather according to claim 1, characterized in that at least one surface of a completely finished leather, of which at least 10% of the cross section from the surface has been rendered hydrophobic, is buffed with a solid abrasive.

10. Process according to claim 9, characterized in that the particle size of the abrasive is from 260 μm to 5 μm.

11. Process according to claim 9, characterized in that the contact angle θ of a water drop on the surface of the completely finished leather is from 70° to 120°.

12. Leather obtainable by a process according to claim 9.

13. Use of leathers according to claim 1 for the production of commodities in the shoe, apparel, automotive and furniture industry.

14. Use of leathers according to claim 12 for the production of commodities in the shoe, apparel, automotive and furniture industry.
